(19) United States
(12) Patent Application Publication
(10) Pub. No.: US 2015/0367499 A1
(43) Pub. Date: Dec. 24, 2015

(54) HANDLE FOR CLEANING TOOL OR SIMILAR

(71) Applicant: ERRE USE EVOLUTION, S.L., Leioa (Bizkaia) (ES)

(72) Inventor: Unai Arketa Zabala, Leioa-Vizcaya (ES)

(21) Appl. No.: 14/764,677

(22) PCT Filed: Sep. 30, 2013
(86) PCT No.: PCT/ES2013/070673

§ 371 Date: Jul. 30, 2015

(30) Foreign Application Priority Data
Mar. 6, 2013 (ES) U201330269

(51) Int. Cl. B25G 1/10; A47L 13/46; B25G 3/00

(52) U.S. Cl. CPC B25G 1/10; B25G 3/00; A47L 13/46

(57) ABSTRACT

Handle for cleaning tool or similar which has an elbow at an intermediate point which defines a lower straight section and an upper section which externally forms a widened surface with a configuration and length adapted to the forearm of an individual which at the front end ends in a flexible clamp which secures the forearm of the user in an area close to the elbow while on the same exterior face and close to the angled area of the handle there is a handhold in such a manner that it can be applied both on the ground or on a low surface as well as on the ceiling or an elevated surface above the head of the user.

### OBJECT OF THE INVENTION

The present invention relates, as is set out in the title, to a handle of the type which is used in brooms or other cleaning tools, although it can also be used as an accessory for paint rollers or any other tools which use an elongated handle which, for the use thereof, is held at an area close to the front end, whether it be with one or with two hands.

### BACKGROUND OF THE INVENTION

At present there exist on the market handles for brooms, brushes, rollers, etc. formed by an elongated element made of wood, plastic or metal, fixed or telescopic which are held with the hands at the area of the front end, mounting the tool at the opposing end, normally fitted at pressure, threaded or interlocked with any type of clamp.

Over the years the handles have hardly evolved in the structure and configuration thereof for making them more ergonomic and adaptable to different types of tools, which require a specific termination for the use thereof.

### DESCRIPTION OF THE INVENTION

The object of the present invention is therefore a handle which has a novel configuration and structure which make it particularly suitable for the use thereof with different tools while allowing the use of the tool in areas which were hitherto inaccessible with a conventional handle and in comfortable and ergonomic conditions for the user.

The handle of the invention has an elbow at an intermediate point, from which two section are visible: one straight lower section, at times telescopic, and an upper section which externally (on the convex face) forms a widened surface which has a configuration and length suited to the forearm. This front or upper section has at the end a termination in the form of a clamp in which it is secured to the forearm by way of an area close to the elbow while close to the angled area there is a protrusion in the form of a handle such that the entire front area of the handle is coupled on the hand and the arm of the user. The lower section of the handle, extension of the support and upper handholds forms with the latter an angle of between 135° and 165° so that when the tool is applied on the ground or on a low surface the work is effected with the arm slightly folded at the elbow whereas if work is carried out on the ceiling or on an elevated area, the position of the arm is also elevated but forming an angle approximate to 45° with the horizontal which is much more comfortable than if the arm had to be completely elevated in order to be able to access the ceiling with the tool which is being handled at that moment.

The handhold is a straight grip, fixed, perpendicular to the handle at the area of the front section. Optionally, another more complex alternative is possible, such as a transversal grip which allows the fist to be located in a position close to the horizontal or a grip adjustable in length or laterally so that it can be located as the user desires.

The exterior surface of the widened area and/or the flexible clamp, that is to say the entire area which is in contact with the forearm, optionally are soft or padded for greater comfort of the user.

The straight lower section is preferably telescopic with the aim of being adapted to the stature or preference of the individual.

### DESCRIPTION OF THE FIGURES

In order to complement the description and with the aim of facilitating the understanding of the characteristics of the invention, a set of drawings accompany the present specification, in which the following are depicted in an illustrative and non-limiting manner:

FIG. 1 shows an elevated view of this handle when the tool is used on the ground or on a low surface.

FIG. 2 is a view of the same tool in the position of use when it is used on the ceiling or on an elevated surface.

### PREFERRED EMBODIMENT OF THE INVENTION

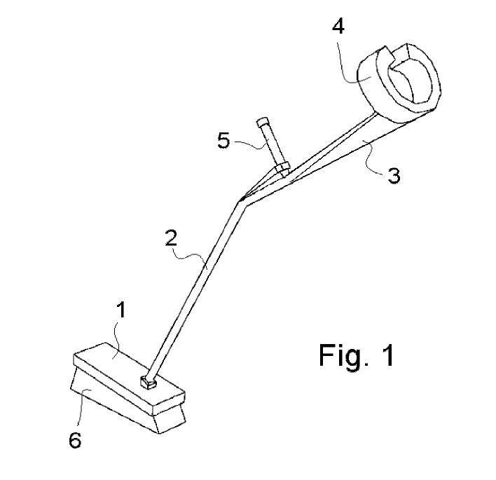

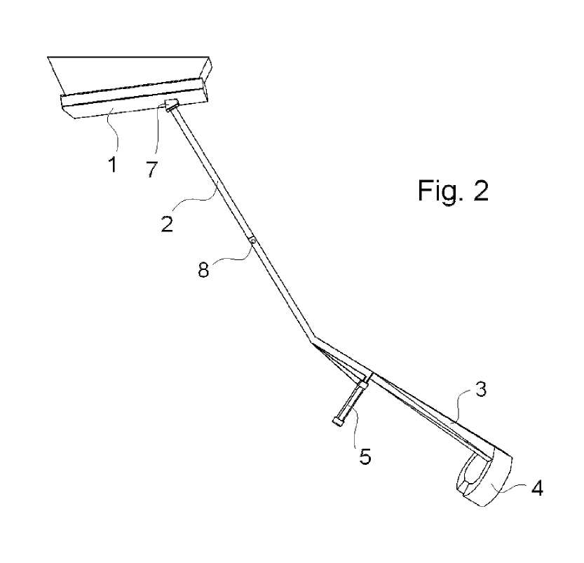

As can be observed in the referenced figures, the handle of the invention has a first straight area (2) and is provided at the rear end with a termination (7) in which it fits in the cleaning tool (1). A second portion (3) which forms an obtuse angle with the foregoing of between 175° and 135°. On the exterior face of this portion (3), that is to say, in the convex area keeping them at the angle which forms both sections of the handle, three elements are arranged:
an intermediate widened area which is adapted to the forearm of the user, both when it is held in the natural position represented in FIG. 1 as well as in the inverse position, shown in FIG. 2.
a flexible clamp (4) open through the exterior and located at the end of the portion (3) which accommodates the forearm and allows the piece to be firmly secured in relation to the latter.
a handle or hand grip (5) located close to the angle which the two sections (2-3) of the handle form.

With this configuration, it is possible to hold the handle in a natural position, as the position marked in FIG. 1, introducing the forearm into the clamp (4), while with the hand the grip (5) is held. In this way, it is possible to sweep or gain access with the tool (1) to corners which would otherwise be inaccessible. If an angled termination is also provided for the bristles or existing cleaning elements (6) in the tool (1), this facilitates the operation.

In FIG. 2, the form of gripping this tool in the inverse position is observed. In this case, it is placed below the forearm, such that the clamp (4) is also secured close to the elbow, however, from the top downwards, while the grip (5) inserted inverted with the termination downwards. This position is ideal for painting or cleaning ceiling surfaces or surfaces which are elevated above the head of the operator. In this way, all the force made with the arm is transmitted directly to the stick, minimizing the effort and saving time.

The bristles of the broom (6) are envisaged to go from few to many in order to obtain the suitable angle and in this way be able to access low parts of chairs, tables, sofas, etc. This exercise is carried out with one single hand, being able to have the collector in the other and in this way collect the dirt in each sweep without having to pile it together beforehand.

Once the nature of the invention, as well as a preferred exemplary embodiment have been sufficiently described, it must be noted in an appropriate manner that the materials, shape, size and arrangement of the elements described can be modified, provided this does not involved an alteration of the essential characteristics of the invention which is claimed below:

What is claimed is:

1. A handle for cleaning tool or similar which comprises an elongated body which the end has a coupling means (7) with a tool (1) which can be applied both on the ground or a low surface such as on the ceiling or an elevated surface above the head of the user, characterized in that it has an elbow at an intermediate point which defines a lower straight section (2) and an upper section (3) which externally (on the convex face) forms a widened surface with a configuration and length adapted to the forearm of an individual, which at the front end ends in a flexible clamp (4) which secures the forearm of the user in an area close to the elbow while on the same exterior face and close to the angled area of the handle there is a handhold (5).

2. The handle for cleaning tool or similar according to claim 1, characterized in that the lower section (2) and the upper section (3) of the same form an angle of between 135° and 165°.

3. The handle for cleaning tool or similar according to claim 1, characterized in that the handhold (5) is a straight grip, fixed, perpendicular to the front area (3) of the handle close to the angle which forms the handle in the intermediate area.

4. The handle for cleaning tool or similar according to claim 1, characterized in that the exterior surface of the widened area (3) and/or the flexible clamp (4) are soft or padded.

5. The handle for cleaning tool or similar according to claim 1, characterized in that the lower section (2) is telescopic.
